(19) United States
(12) Patent Application Publication
(10) Pub. No.: US 2014/0120023 A1
(43) Pub. Date: May 1, 2014

(54) METHODS AND SYSTEMS FOR AMMONIA PRODUCTION

(71) Applicant: GENERAL ELECTRIC COMPANY, Schenectady, NY (US)

(72) Inventors: Surinder Prabhjot Singh, Schenectady, NY (US); Anthony Yu-Chung Ku, Niskayuna, NY (US); Scott Michael Miller, Clifton Park, NY (US); Roger Allen Shisler, Ballston Spa, NY (US); Dhaval Ajit Bhandari, Troy, NY (US)

(73) Assignee: GENERAL ELECTRIC COMPANY, Schenectady, NY (US)

(21) Appl. No.: 13/665,370

(22) Filed: Oct. 31, 2012

(51) Int. Cl. C01C 1/04; B01J 14/00

(52) U.S. Cl. 423/359; 422/162

(57) ABSTRACT

A method for ammonia synthesis using a water-gas shift membrane reactor (WGSMR) is presented. The method includes carrying out a water-gas shift reaction in the WGSMR to form a first product stream and a carbon dioxide (CO₂) stream, wherein the first product stream includes nitrogen (N₂) and hydrogen (H₂), and a molar ratio of H₂ to N₂ in the first product stream is about 3. The method further includes separating at least a portion of the residual CO₂ in the first product stream in a CO₂ separation unit to form a second product stream, and separating at least a portion of the residual CO₂ and carbon monoxide (CO) in the second product stream in a methanator unit to form a third product stream. The method further includes generating an ammonia stream from the third product stream in an ammonia synthesis unit. A system for ammonia synthesis is also presented.

This invention was made with Government support under contract number DE-AC07-05ID14517, awarded by the DOE. The Government may have certain rights in the invention.

### BACKGROUND OF THE INVENTION

The invention relates generally to methods and systems for ammonia production. More particularly, the invention relates to methods and systems for ammonia production using a water-gas shift gas membrane reactor.

Ammonia synthesis is an important industrial process Ammonia is produced in very large quantities worldwide, for use in the fertilizer industry, as a precursor for nitric acid and nitrates for the explosives industry, and as a raw material for various industrial chemicals. The prevalent method of synthesizing ammonia includes reaction of hydrogen (H₂) with nitrogen (N₂) in stoichiometric amounts using a suitable catalyst. Hydrogen required for the ammonia synthesis is typically obtained by steam methane reforming (SMR) of natural gas or by coal gasification, followed by water-gas shift (WGS) reaction.

However, conventional methods to generate H₂ typically involve a two-stage WGS reaction. The two-stage WGS reaction includes a high-temperature shift (HTS) and a low-temperature shift (LTS). The HTS is used to obtain a higher reaction rate, but it suffers from the disadvantage that it leads to a poor conversion (equilibrium favored at lower temperatures). The LTS is then used in the second stage to obtain a better conversion rate. However, LTS may result in lower reaction rates. The resulting product from the two-stage WGS reactor is then transferred to a carbon dioxide (CO₂) removal system where the H₂ is separated from CO₂. The H₂ is then mixed with the N₂ (added separately to the H₂ stream after CO₂ removal step), and after compression is sent for ammonia synthesis.

Thus, the conventional ammonia synthesis methods and systems involve multiple steps, may require large capital investment (requiring large capacity CO₂ removal unit and two-stage WGS reactors), and may suffer from low CO to CO₂ conversion rates and lower efficiencies. Accordingly, there is a need for cost-effective and efficient methods and systems for ammonia synthesis.

### BRIEF DESCRIPTION OF THE INVENTION

One embodiment is directed to a method. The method comprises:
(i) receiving a syngas stream, a water vapor stream, and a nitrogen (N₂) sweep gas stream in a water-gas shift membrane reactor;
(ii) carrying out a water-gas shift reaction in the water-gas shift membrane reactor to form a first product stream and a carbon dioxide (CO₂) stream, wherein the first product stream comprises nitrogen (N₂) and hydrogen (H₂), and a molar ratio of H₂ to N₂ in the first product stream is about 3;
(iii) receiving at least a portion of the first product stream in a CO₂ separation unit, and separating at least a portion of the residual CO₂ in the first product stream to form a second product stream;
(iv) receiving at least a portion of the second product stream in a methanator unit, and separating at least a portion of the residual CO₂ and carbon monoxide (CO) in the second product stream to form a third product stream; and
(v) receiving at least a portion of the third product stream in an ammonia synthesis unit, and generating an ammonia stream from the third product stream.

Another embodiment of the invention is directed to a method, comprising:
(i) generating a syngas stream in a gasification unit or a catalytic partial oxidation (CPO) unit;
(ii) receiving the syngas stream, a water vapor stream, and a nitrogen sweep gas stream in a water-gas shift membrane reactor;
(iii) reacting the syngas stream with the water vapor stream in the water-gas shift membrane reactor to form carbon dioxide and hydrogen, and transferring at least a portion of hydrogen to the nitrogen sweep gas stream to form a first product stream, wherein a molar ratio of H₂ to N₂ in the first product stream is about 3;
(iv) receiving at least a portion of the first product stream in a CO₂ separation unit, and separating at least a portion of the residual CO₂ in the first product stream to form a second product stream;
(v) receiving at least a portion of the second product stream in a methanator unit, and separating at least a portion of the residual CO₂ and carbon monoxide (CO) in the second product stream to form a third product stream; and
(vi) receiving at least a portion of the third product stream in an ammonia synthesis unit, and generating an ammonia stream from the third product stream.

Another embodiment of the invention is directed to a system, comprising:
(i) a water-gas shift membrane reactor configured to receive a syngas stream, a water vapor stream, and a nitrogen sweep gas stream to form a first product stream and a first carbon dioxide (CO₂) stream, wherein the first product stream comprises nitrogen (N₂) and hydrogen (H₂), and a molar ratio of H₂ to N₂ in the first product stream is about 3;
(ii) a CO₂ separation unit configured to receive the first product stream and capable of separating at least a portion of the residual CO₂ in the first product stream to form a second product stream;
(iii) a methanator unit configured to receive the second product stream and capable of separating at least a portion of the residual CO₂ and carbon monoxide (CO) in the second product stream to form a third product stream; and
(iv) an ammonia synthesis unit configured to receive the third product stream and configured to generate an ammonia stream from the third product stream.

### DRAWINGS

These and other features, aspects, and advantages of the present invention will become better understood when the following detailed description is read with reference to the accompanying drawings, in which like characters represent like parts throughout the drawings, wherein:

FIG. 1 illustrates a system for ammonia production, according to an embodiment of the invention;

FIG. 2 illustrates a schematic of a water-gas shift membrane reactor, according to an embodiment of the invention;

FIG. 3a illustrates a schematic of a water-gas shift membrane reactor, according to an embodiment of the invention;

FIG. 3b illustrates a schematic of a water-gas shift membrane reactor, according to an embodiment of the invention;

FIG. 4 illustrates a system for ammonia production, according to an embodiment of the invention; and

FIG. 5 illustrates a system for ammonia production, according to an embodiment of the invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill, having the benefit of this disclosure.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

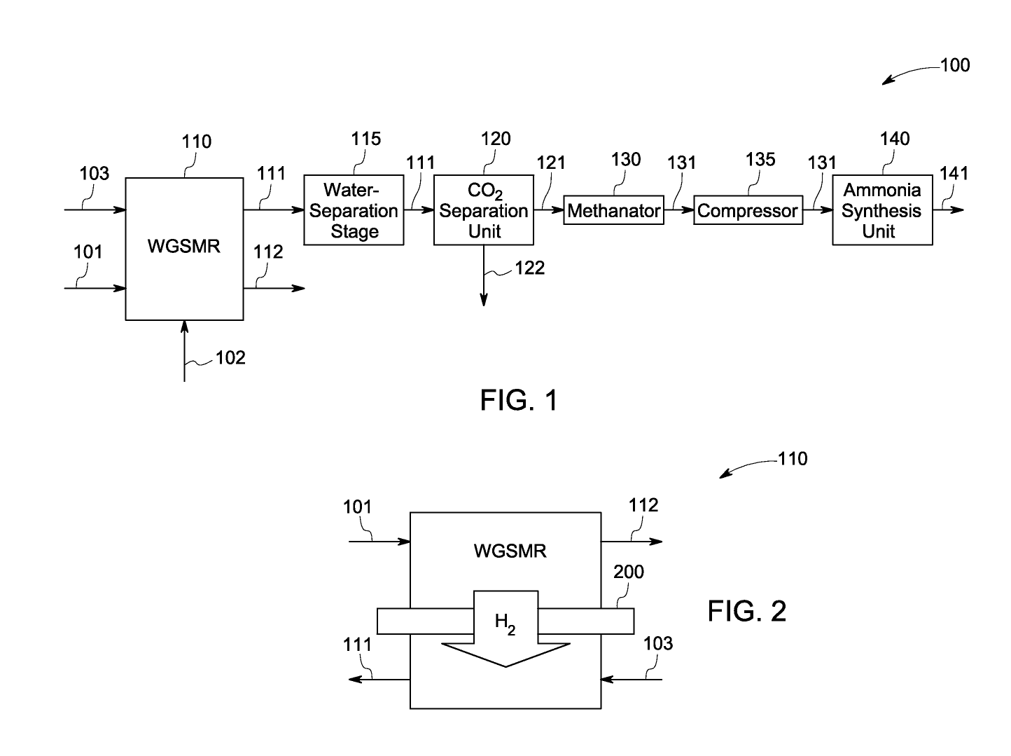

FIG. 1 schematically represents a method and system for ammonia production as per one embodiment of the present invention. The method includes receiving a syngas stream 101, a water vapor stream 102, and a nitrogen sweep gas stream 103 in a water-gas shift membrane reactor 110. The method further includes carrying out a water-gas shift reaction in the water-gas shift membrane reactor 110 to form a first product stream 111 and a first carbon dioxide (CO₂) stream 112. The first product stream 111 includes nitrogen (N₂) and hydrogen (H₂).

The term “water-gas shift membrane reactor”, as used herein, refers to a reactor configured to perform the water-gas shift reaction to convert carbon monoxide (CO) in the syngas stream 101 to hydrogen (H₂) and carbon dioxide (CO₂), by reaction with steam (H₂O). The water-gas shift reaction may be further represented by the chemical reaction CO+H₂O→H₂+CO₂. The reactor further includes a H₂-selective membrane configured to separate at least a portion of H₂ from CO₂. Thus, the water-gas shift membrane reactor 110 is an integrated system capable of performing both the water-gas shift reaction and the H₂ separation in a single unit.

An integrated water-gas shift reactor and separation unit enables shifting of the equilibrium reaction in the forward direction by continuously removing the H₂ that is generated, which in turn acts to shift the WGS reaction equilibrium in a direction favorable to higher CO conversion. Further, by driving the equilibrium in the forward direction, the water-gas shift reaction may be effected at lower temperatures. Moreover, the reaction may advantageously use lower steam/CO ratios when compared to a multi-stage water gas shift reactor (that includes a separate H₂ separator). Herein, throughout the specification, the term “WGSMR” is used for the water-gas shift membrane reactor and the term “WGS reaction” is used the water-gas shift reaction, for the sake of brevity.

The syngas stream 101 refers to a gaseous mixture of carbon monoxide (CO) and hydrogen (H₂) present in varying amounts. As will be described in detail later, the syngas stream 101 may be produced by any suitable production scheme, such as, for example, gasification of a solid fuel (for example, coal) or catalytic partial oxidation of a hydrocarbon feedstock (for example, natural gas). In some embodiments, the syngas stream 101 may further include impurities or pollutants, examples of which include, but are not limited to, nitrogen oxides, sulfur oxides, hydrogen sulfide, unburnt hydrocarbons, particulate matter, and combinations thereof. In such embodiments, the syngas stream 101 may be further subjected to one or more cleaning steps to remove the impurities or pollutants prior to receiving the syngas stream in the WGSMR 110. In alternate embodiments, the syngas stream 101 may be substantially pure after the gasification or partial oxidation step, and may not require a cleaning step prior to receiving the syngas stream in the WGSMR 110. The pressure of the syngas stream 101 received at the WGSMR may be in a range from about 1 bar to about 30 bar. The temperature of the syngas stream 101 received at the WGSMR may be in a range from about 190° C. to about 420° C.

The term nitrogen (N₂) sweep gas stream 103 as used herein refers to a sweep gas stream including N₂ gas at high pressure. As noted earlier, at least a portion of H₂ is separated in the WGSMR via the H₂-selective membrane. The sweep gas stream 103 may allow for separation of H₂ in the WGSMR by transferring at least a portion of H₂ to the sweep gas stream 103. As will be described in detail below, the nitrogen sweep gas stream 103 may be received at WGSMR 110 from a suitable nitrogen source. Thus, by way of example, in certain embodiments, the N₂ sweep gas stream 103 may be generated using an air separation unit (ASU). The N₂ sweep gas stream 102 may be substantially dry or may further include a water vapor content. In embodiments wherein the N₂ sweep gas stream may further include a water vapor content, the wet N₂ sweep gas stream may reduce the transfer of steam from the upstream to downstream side, and thus preclude the membrane from being devoid of steam.

In some embodiments, the pressure of the N₂ sweep gas stream 103 may be in a range from about 1 bar to about 30 bar. The amount of water-vapor (or steam) 102 added to the WGSMR 110 may depend, in part, on one or more of the composition of the syngas stream, the reaction temperatures employed, or the equilibrium conditions during the WGS reaction.

It should be noted that the direction of flow into the WGSMR of the various input streams (such, as for example, 101, 102 and 103) in FIGS. 1 and 2 is for illustration purposes only and may vary depending on the desired WGSMR performance. Thus, by way of example, in some embodiments, the N₂-sweep gas stream 103 is caused to flow in a direction that is counter-current to the flow of the syngas stream 101, to increase the efficiency for a given volume of the membrane reactor, as illustrated in FIG. 2. Further, one or more of the three streams, that is, the syngas stream 101, the N₂ sweep gas stream 103, and the water-vapor stream 102, may be received simultaneously or sequentially in the WGSMR 110.

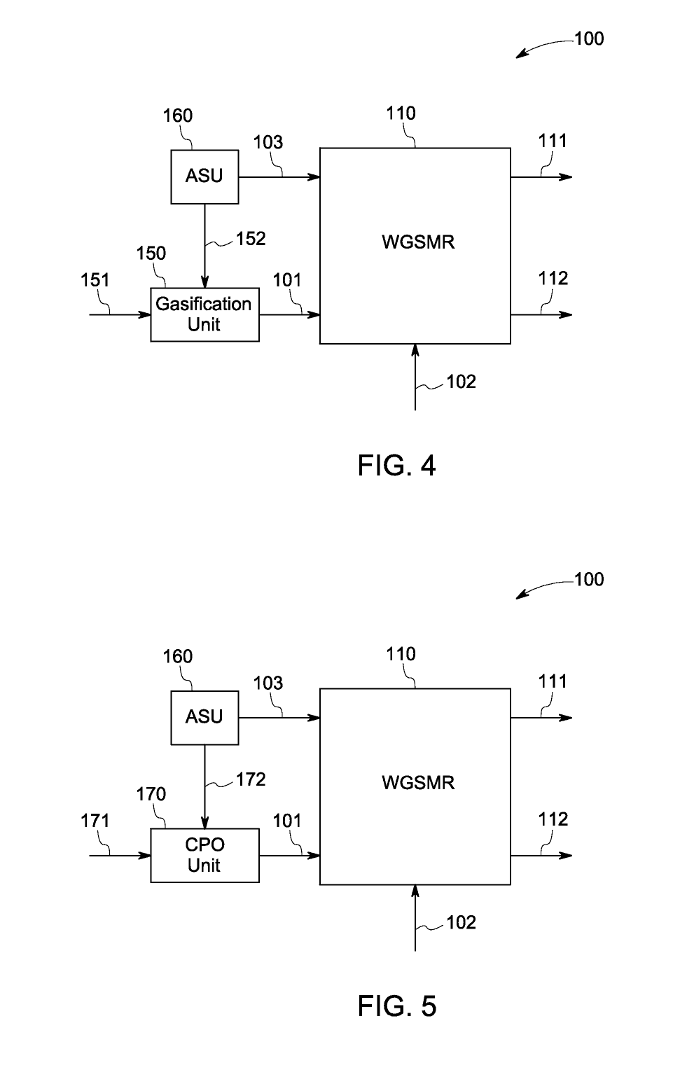

As described above, in some embodiments, the method further includes generating the syngas stream 101 in a gasification unit or a catalytic partial oxidation unit. Referring now to FIG. 4, in one embodiment, the method includes generating the syngas stream 101 from a fuel stream 151 and an oxidant stream 152 in a gasification unit 150. A suitable fuel in the fuel stream 151 may include a solid hydrocarbon fuel. As used herein, the term “gasification unit” refers to any gasification unit known in the art which is capable of processing hydrocarbon fuel in order to produce a syngas stream that includes at least H₂ and CO₂. As used herein, the term “hydrocarbon fuel” refers to any solid fuel, liquid fuel, solid fuel source, or liquid fuel source which is derived from organic materials such as refinery residue materials (for example, tar, heavy oils, petcoke, coke, or coal) or biofuels (for example, wood, peat, corn, corn husks, wheat, rye, or other grains). In certain embodiments, the syngas stream 101 may be generated from coal in the gasification unit 150. Such embodiments of the invention provide for synthesis of ammonia from coal.

Some other embodiments of the present invention provide for synthesis of ammonia from natural gas. The term “natural gas” as used herein refers to hydrocarbon gas or a hydrocarbon gas mixture primarily comprised of methane. In certain embodiments, the natural gas includes a mixture of methane with other hydrocarbons. The natural gas may further include other components, such as for example, carbon dioxide, nitrogen, and hydrogen sulfide.

In such embodiments, the method may further include generating the syngas stream 101 in a catalytic partial oxidation (CPO) unit 170 from a natural gas stream 171 and an oxidant stream 172, and receiving the syngas stream 101 in the WGSMR 110 from the CPO unit 170, as indicated in FIG. 5. This is in contrast to conventional methods of natural gas to syngas, which typically include multiple steam methane reforming (SMR) steps, resulting in the generation of N₂-containing syngas, which requires additional cleaning steps.

In some embodiments, the method may further include generating the oxidant stream 152/172 and the N₂ sweep gas stream 103 in an air separation unit (ASU) 160, as also depicted in FIG. 5. The resultant N₂ sweep gas stream 103 is received in the WGSMR 110 from the ASU 160; and the oxidant stream 152/172 is received in the gasification unit 150 or the CPO unit 170 from the ASU 160, as illustrated in FIGS. 4 and 5. The term “oxidant stream” as used herein may refer to oxygen (O₂), natural air, or O₂-enriched air. Gasification units, CPO units, and ASU units such as those proposed for the present process are readily known to those skilled in the art.

As noted earlier, the method further includes reacting the syngas stream 101 with the water vapor stream 103 (for example, steam) to form CO₂ and H₂ in the WGSMR 110. As will be appreciated by one of ordinary skill in the art, the percentage conversion of CO to CO₂ in the WGSMR may be controlled, at least in part, by varying one or more of reaction conditions, such as, for example, the syngas (H₂/CO) ratio, CO to steam ratio (CO/H₂O), and the reaction temperature.

In some embodiments, a molar ratio of CO to H₂ in the syngas stream 101 is in a range from about 1 to about 4.5. In some embodiments, a molar ratio of CO to H₂ in the syngas stream 101 is in a range from about 1.5 to about 3. Different techniques may be employed to adjust the syngas ratio to a desired value, depending on the method of generation of syngas. Thus, by way of example, in embodiments wherein the syngas stream 101 is generated by catalytic partial oxidation (CPO) of natural gas, the molar ratio of CO to H₂ may be controlled by varying at least one of the oxygen-to-carbon ratio or the steam-to-carbon ratio in the CPO unit. Depending on the desired syngas ratio for the WGSMR, the amount of oxidant, steam, and natural gas may be controlled relative to each other in the CPO unit, to attain the desired oxygen-to-carbon and steam-to-carbon ratios.

The WGS reaction in the WGSMR may be carried out at a temperature in a range from about 190° C. to about 420° C., in some embodiments. In some embodiments, the WGS reaction may be carried out at a temperature in a range from about 280° C. to about 420° C. Thus, embodiments of the invention may enable higher reaction rates and improved conversion of CO to CO₂ at lower reactor temperatures when compared to conventional multi-stage WGS reactors.

As mentioned earlier, the percentage conversion of CO to CO₂ may be further increased by continuously driving the reaction in the forward direction by removing at least a portion of H₂ via the H₂-selective membrane in the WGSMR. FIG. 2 presents a schematic illustration of the operation of a WGSMR 110. As illustrated in FIG. 2, at least a portion of H₂ is separated from the CO₂ in the WGSMR, via the H₂-selective membrane 200, and is further transferred to the N₂ sweep gas stream to form a first product stream 111.

As will be appreciated by one of ordinary skill in the art, the portion of H₂ transferred to the N₂ sweep gas stream 103 may include at least a portion of the H₂ present in the syngas stream 101, at least a portion of the H₂ generated in the WGSMR, or both (FIG. 1). In some embodiments, at least about 70 volume percent of the total H₂ volume (from the syngas stream and the WGS reaction product) is transferred to the N₂ sweep gas stream 103. In some embodiments, at least about 90 volume percent of the total H₂ volume (from the syngas stream and the WGS reaction product) is transferred to the N₂ sweep gas stream 103. In certain embodiments, the portion of H₂ transferred to the N₂ sweep gas stream 103 may be tailored to obtain a desired molar ratio of H₂ to N₂.

The molar ratio of H₂ to N₂ in the first product stream 111 may be optimized for efficient ammonia synthesis. Different techniques may be used to adjust the molar ratio to a desired value. In some embodiments, the method may include varying one or more of a reactor dimension, a membrane area, a membrane permeability, a membrane temperature, a pressure differential across the membrane, a membrane selectivity, a syngas flow rate, or a N₂ sweep gas flow rate, to control the molar ratio of H₂ to N₂ in the first product stream 111. In certain embodiments, the molar ratio of H₂ to N₂ in the first product stream 111 is about 3. As used herein, a ratio of “about 3” refers to a value greater than 2.5 and less than 3.5. In some embodiments, a molar ratio of H₂ to N₂ in the first product stream 111 is in a range from about 2.75 to about 3.25. In certain embodiments, a molar ratio of H₂ to N₂ in the first product stream 111 is in a range from about 2.95 to about 3.25.

Without being bound by any theory, it is believed that embodiments of the present invention advantageously provide for a substantially stoichiometric mixture of H₂ and N₂ in the first product stream 111, which may eventually result in more efficient ammonia synthesis. Further, the N₂ gas is added to the H₂ in the WGSMR itself as a sweep gas, and embodiments of the method may preclude the need for a separate step of mixing N₂ with H₂, prior to ammonia synthesis.

The WGSMR may have any suitable configuration for its intended purpose. The integrated WGSMR as described herein includes a catalyst to catalyze the WGS reaction, and a H₂-selective membrane for separating H₂ from the CO₂. In certain embodiments, a suitable catalyst used in the WGSMR is a water gas shift catalyst, which is active at a low steam to CO molar ratio, and at a relatively low inlet temperature, without favoring side reactions such as methanation. Suitable non-limiting examples of the catalyst include iron (Fe), nickel (Ni), a noble metal catalyst such as palladium (Pd), platinum (Pt), rhodium (Rh), Ruthenium (Ru), oxides or sulphides of molybdenum (Mo) or cobalt (Co), and combinations comprising at least one of the foregoing catalysts, such as ferro-chromium (Fe—Cr) alloys, platinum-rhenium (Pt—Re) alloys, and so forth. In some embodiments, the catalyst may be supported on a suitable carrier or support, such as, for example, high surface area ceramics such as cerium oxide (CeO₂), zirconium oxide, aluminum oxide (Al₂O₃), cordierite, and combinations comprising at least one of the foregoing supports.

The term “H₂-selective membrane” as used herein refers to a membrane, which allows for the preferential passage of H₂ while limiting the passage of other components, and which allows for the separation of at least a portion of H₂ from CO₂ In accordance with some embodiments of the invention, the H₂-selective membrane has a permselectivity of H₂ over CO₂ of at least about 10. The term “permselectivity” of a membrane as used herein refers to the ratio of the permeance of H₂ to the permeance of CO₂. In some embodiments, the H₂-selective membrane may have a permeability greater than about 30 gas permeation units (GPU), wherein 1 GPU is equal to 1×10⁻⁶ cm³ (STP)/(cm².sec.cmHg)

As noted, the membrane type that may be utilized in the WGSMR is highly selective for H₂. Such H₂-selective membranes may be comprised of H₂-permeable and H₂-selective materials, and may be capable of operating in a temperature range of about 150° C. to about 500° C. Suitable non-limiting examples of H₂-selective membranes include certain organic membranes (for example, polymeric membranes); inorganic membranes (for example, metallic, silica, ceramic, carbon, zeolite, oxide or glass membranes); supported-liquid or facilitated transport membrane membranes; hybrid or mixed-matrix membranes comprised of inorganic particles (for example, zeolite, carbon, metal and metal oxides) as the dispersed phase and a polymer matrix as the continuous phase materials, and combinations thereof.

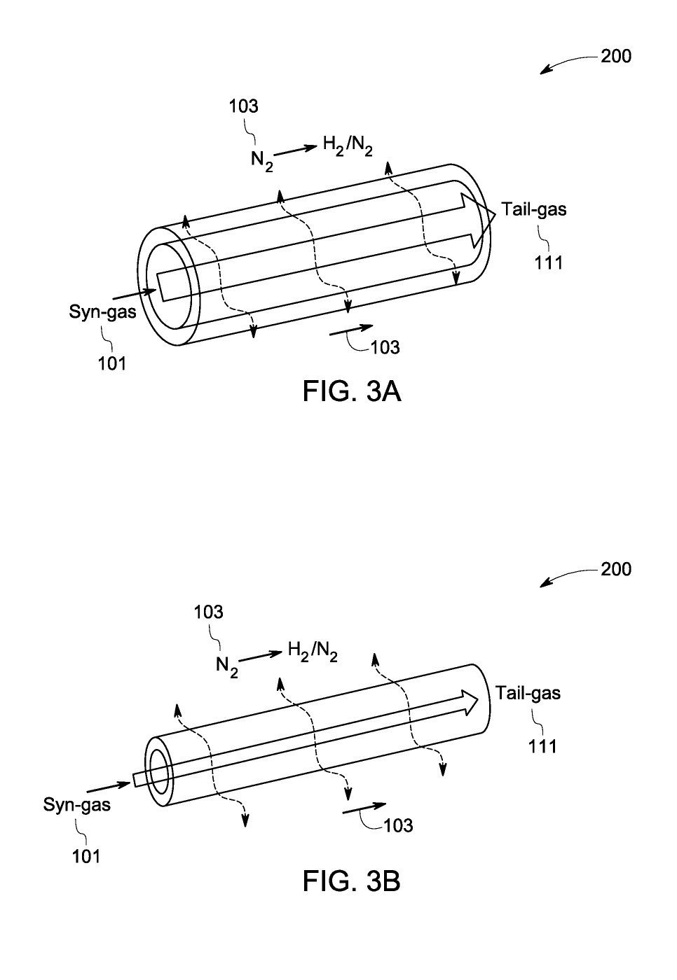

The H₂-selective membrane 200 may have any known configuration suitable for application in the present invention. Examples of suitable membrane configurations, may depend, in part, on the membrane material, and may include, flat sheet, spiral wound, tubular, hollow fibre, or monolithic (multi-channel) configurations. FIG. 3a illustrates an exemplary H₂-selective membrane 200 configuration, wherein the WGS-MR includes a porous tube with a H₂-selective membrane coated on a tube wall and with the catalyst provided on a surface of the tube. As will be appreciated by one of ordinary skill in the art, the H₂-selective membrane may coated inside or outside of the tube and the catalyst be may packed inside or outside of the tube. FIG. 3b illustrates another exemplary H₂-selective membrane 200 configuration including a polymeric hollow fiber. As illustrated in FIGS. 3a and 3b, the product stream including H₂ and N₂ is removed from the H₂/CO/CO₂ gaseous mixture, via the H₂-selective membrane 200. It should be noted that although FIGS. 3a and 3b illustrate embodiments wherein the syngas stream flow is inside the tube/fiber and the N₂ sweep gas stream flow is outside the tube/fiber, embodiments of the invention described herein also encompass scenarios wherein the direction of flow is reversed, that is, the N₂ sweep gas stream flows inside the tube/fiber and the syngas stream flow is outside the tube/fiber. Some specific membrane materials and configurations are described in U.S. Patent Publication Nos. 2007/0072949, 2011/0020188, 2011/0099969, and 2011/0030384, incorporated herein by reference so long as directly contradictory the teachings described herein.

Further, the membrane may be positioned in a single membrane unit (stage) or in several units, wherein each unit may be comprised of one or more separate membranes. Typically, the number of membrane units may depend on the surface area of the separate membranes in combination with the required quantity of H₂ to be permeated. The membrane units may include H₂ separation membranes of the same type, or a different type, in terms of composition or configuration. As a consequence, the membrane units may differ from each other, in terms of one or more of shape, H₂ permeance, H₂ permselectivity, or surface area available for permeation. Furthermore, the membranes may be arranged in series or in parallel, for example.

As noted earlier, some embodiments of this invention include forming the product stream 111 and CO₂ stream 112. The CO₂ stream 112 primarily comprises CO₂ and may further include additional gases, such as, for example, CO, N₂, and H₂. The method may further include subjecting the CO₂ stream 112 to one or more treatment steps such that the CO₂ stream is rendered suitable for its intended use. In certain embodiments, the CO2 stream 112 may be further treated in a water-separation stage (not shown), wherein any residual water content in the CO₂ stream may be removed. The CO₂ stream 112 formed by separating H₂ from the CO₂ in the WGSMR is sometimes referred to as “tail gas” in the art. The CO₂ stream 112 formed by separating H₂ from the CO₂ in the WGSMR may also be referred to as a “first CO₂ stream” 112, to differentiate it from the CO₂ stream formed in the CO₂ separation unit 120.

The product stream 111 is primarily comprised of N₂ and H₂, as discussed earlier. However, the product stream 111 may also further include additional gases, such as, for example, CO, CO₂, H₂S, water vapor, or combinations thereof. In some embodiments, the product stream 111 formed in the WGSMR 110 may be further treated in a water-separation stage 115 wherein any residual water content in the CO₂ stream may be removed, as indicated in FIG. 1. As one or more of the aforementioned CO and CO₂ gases may poison the ammonia synthesis catalyst, the method further includes separating the gases from the product stream. Referring again to FIG. 1, the method includes receiving at least a portion of the first product stream 111 in a CO₂ separation unit 120, and separating at least a portion of the residual CO₂ in the first product stream 111 to form a second product stream 121. The method may further include forming a second CO₂ product stream 122 in the CO₂ separation unit 120. The CO₂ separation unit 120 may have any suitable configuration, and may include a membrane-based, amine-solvent based, or any other suitable CO₂ removal system.

The method further includes receiving at least a portion of the second product stream 121 in a methanator unit 130, and separating at least a portion of the residual CO₂ and carbon monoxide (CO) in the second product stream 121 to form a third product stream 131. The method may further include forming a methane (CH₄) product in the methanator unit 120, and the third product stream 131 may further comprise the CH₄ formed in the methanator unit. The methanator unit 130 may have any suitable configuration and catalyst composition, and is well known to those skilled in the art. In some embodiments, the third product stream 131 may be further compressed in a compression unit 135, such that, the pressure of the third product stream may be increased (for example, up to about 200 bar), as indicated in FIG. 1.

The method further includes receiving at least a portion of the third product stream 131 in an ammonia synthesis unit 140, and generating an ammonia stream 141 from the third product stream 131. As will be apparent to those skilled in the art, the third product stream 131 essentially includes H₂ and N₂, such that a molar ratio of H₂ to N₂ is about 3. Thus, embodiments of the present invention advantageously provide for efficient ammonia synthesis by controlling the H₂/N₂ ratio in the third product stream 131. Further, in contrast to conventional ammonia synthesis methods, embodiments of the present invention preclude the need for providing N₂ separately to the ammonia synthesis unit 140, thus eliminating additional steps.

Another embodiment of the invention is directed to a system 100 that includes a WGSMR 110 configured to receive a syngas stream 101, a water vapor stream 102, and a N₂ sweep gas stream 103 to form a first product stream 111 and a first CO₂ stream 112, as indicated in FIG. 1. As described in detail earlier, the first product stream 111 includes N₂ and H₂, and a molar ratio of H₂ to N₂ in the first product stream 111 is about 3. The WGSMR 110 may be configured to vary one or more of a reactor dimension, a membrane area, a membrane permeability, a membrane selectivity, a membrane temperature, a pressure differential across the membrane, a syngas flow rate, or a N₂ sweep gas flow rate to control the molar ratio of H₂ to N₂ in the first product stream 111. The WGSMR 110 includes a catalyst and a H₂-selective membrane.

Referring now to FIG. 4, in some embodiments, the system 100 may further include a gasification unit 150 configured to receive a fuel stream 151 and an oxidant stream 152, the gasification unit 150 further configured to generate the syngas stream 101. The gasification unit 150 is in fluid communication with the WGSMR 110. In such embodiments, the system 100 is configured to generate ammonia from coal.

Referring now to FIG. 5, in some other embodiments, the system 100 may further include a CPO unit 170 configured to receive a natural gas stream 171 and an oxidant stream 172, the CPO unit 170 further configured to generate the syngas stream 101. The CPO unit 170 is in fluid communication with the WGSMR 110. In such embodiments, the system 100 is configured to generate ammonia from natural gas.

The system 100 may further include an ASU unit 160 configured to generate the oxidant stream 152/172 and the N₂ sweep gas stream 103, the ASU unit 160 in fluid communication with the WGSMR 110 and the gasification unit 150 or the CPO unit 170, as indicated in FIGS. 4 and 5. As used herein, the term “in fluid communication with” implies that different systems or system units are fluidly connected to each other allowing for the passage of fluids. This communication may be direct or indirect, that is passing through some intervening units or sections.

Referring again to FIG. 1, the system 100 further includes a CO₂ separation unit 120 configured to receive the first product stream 111 and capable of separating at least a portion of the CO₂ in the first product stream 111 to form a second product stream 121. As noted earlier, in some embodiments, the system 100 may further include a water separation unit 115 prior to the CO₂ separation unit 120. The system 100 further includes a methanator unit 130 configured to receive the second product stream 121 and capable of separating at least a portion of CO₂ and CO in the second product stream 121 to form a third product stream 131. The system 100 further includes an ammonia synthesis unit 140 configured to receive the third product stream 131 and configured to generate an ammonia stream 141 from the third product stream 131. As noted earlier, in some embodiments, the system 100 may further include a compressor unit 135 prior to the ammonia synthesis unit 140.

Embodiments of the present invention may provide for efficient and cost-efficient ammonia production from coal/natural gas when compared to conventional ammonia synthesis processes/systems. The above-mentioned benefits may be attained, at least in part, by reducing the number of steps (separate addition of N₂ not required), reducing the capital expenditure (smaller methanator and CO₂ separation units), and improved efficiency of CO to CO₂ conversion at lower temperatures and CO/H₂O ratios (by using an integrated WGSMR to drive the equilibrium reaction in the forward direction).

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

1. A method, comprising:
(i) receiving a syngas stream, a water vapor stream, and a nitrogen (N₂) sweep gas stream in a water-gas shift membrane reactor;
(ii) carrying out a water-gas shift reaction in the water-gas shift membrane reactor to form a first product stream and a carbon dioxide (CO₂) stream,
wherein the first product stream comprises nitrogen (N₂) and hydrogen (H₂), and a molar ratio of H₂ to N₂ in the first product stream is about 3;
(iii) receiving at least a portion of the first product stream in a CO₂ separation unit, and separating at least a portion of the residual CO₂ in the first product stream to form a second product stream;
(iv) receiving at least a portion of the second product stream in a methanator unit, and separating at least a portion of the residual CO₂ and carbon monoxide (CO) in the second product stream to form a third product stream; and
(v) receiving at least a portion of the third product stream in an ammonia synthesis unit, and generating an ammonia stream from the third product stream.

2. The method of claim 1, further comprising generating the syngas stream in a gasification unit from a fuel stream and an oxidant stream, and receiving the syngas stream in the water-gas shift membrane reactor from the gasification unit.

3. The method of claim 2, wherein the syngas stream is generated from coal in the gasification unit.

4. The method of claim 2, further comprising generating the oxidant stream and the N₂ sweep gas stream in an air separation unit (ASU), and receiving the N₂ sweep gas stream in the water-gas shift membrane reactor from the ASU, and receiving the oxidant stream in the gasification unit from the ASU.

5. The method of claim 1, further comprising generating the syngas stream in a catalytic partial oxidation (CPO) unit from a natural gas stream and an oxidant stream, and receiving the syngas stream in the water-gas shift membrane reactor from the CPO unit.

6. The method of claim 5, further comprising generating the oxidant stream and the N₂ sweep gas stream in an air separation unit (ASU), and receiving the N₂ sweep gas stream in the water-gas shift membrane reactor from the ASU, and receiving the oxidant stream in the CPO unit from the ASU.

7. The method of claim 1, wherein the method comprises in step (ii) reacting the syngas stream with the water vapor stream to form CO₂ and H₂, and transferring at least a portion of H₂ to the N₂ sweep gas stream to form the first product stream.

8. The method of claim 1, wherein a molar ratio of carbon monoxide to hydrogen in the syngas stream is in a range from about 1 to about 4.5.

9. The method of claim 1, wherein the step (ii) comprises carrying out the water-gas shift reaction at a temperature in a range from about 190° C. to about 420° C.

10. The method of claim 1, wherein the step (ii) comprises varying one or more of a reactor dimension, a membrane area, a membrane permeability, a membrane selectivity, a membrane temperature, a pressure differential across the membrane, a syngas flow rate, or a N₂ sweep gas flow rate to control the molar ratio of H₂ to N₂ in the first product stream.

11. A method, comprising:
(i) generating a syngas stream in a gasification unit or a catalytic partial oxidation (CPO) unit;
(ii) receiving the syngas stream, a water vapor stream, and a nitrogen sweep gas stream in a water-gas shift membrane reactor;
(iii) reacting the syngas stream with the water vapor stream in the water-gas shift membrane reactor to form carbon dioxide and hydrogen, and transferring at least a portion of hydrogen to the nitrogen sweep gas stream to form a first product stream, wherein a molar ratio of H₂ to N₂ in the first product stream is about 3;
(iv) receiving at least a portion of the first product stream in a CO₂ separation unit, and separating at least a portion of the residual CO₂ in the first product stream to form a second product stream;
(v) receiving at least a portion of the second product stream in a methanator unit, and separating at least a portion of the residual CO₂ and carbon monoxide (CO) in the second product stream to form a third product stream; and
(vi) receiving at least a portion of the third product stream in an ammonia synthesis unit, and generating an ammonia stream from the third product stream.

12-20. (canceled)

21. The method of claim 1, wherein a molar ratio of H₂ to N₂ in the first product stream is in a range from about 2.75 to about 3.25.

22. The method of claim 1, wherein a molar ratio of H₂ to N₂ in the first product stream is in a range from about 2.95 to about 3.25.
